(19) United States
(12) Patent Application Publication
(10) Pub. No.: US 2018/0086652 A1
(43) Pub. Date: Mar. 29, 2018

(54) ELECTROLYSIS ELECTRODE FEATURING NANOTUBE ARRAY AND METHODS OF MANUFACTURE AND USING SAME FOR WATER TREATMENT

(71) Applicant: California Institute of Technology, Pasadena, CA (US)

(72) Inventors: Michael R. Hoffmann, South Pasadena, CA (US); Yang Yang, Alhambra, CA (US)

(21) Appl. No.: 15/706,166

(22) Filed: Sep. 15, 2017

Related U.S. Application Data
(60) Provisional application No. 62/401,377, filed on Sep. 29, 2016.

(51) Int. Cl. C02F 1/461; C02F 1/467; C25D 11/26; C23C 4/12; C23C 4/04

(52) U.S. Cl. CPC C02F 1/46109; C02F 1/4672; C25D 11/26; C02F 2103/005; C23C 4/04; C02F 2001/46138; C23C 4/12

(57) ABSTRACT

An electrolysis electrode having an array of nanotubes is disclosed. The electrode may provide high chlorine evolution and hydroxyl radical production activity for electrochemical wastewater treatment. The electrode includes a substrate and a nanotube array contacting the substrate. A semiconductor material overlays the top surface of the nanotube array. The nanotube array may be a stabilized blue-black TiO₂ nanotube array, and the overlying semiconductor material may include TiO₂. Several other improvements may enhance the service life of the electrode. For example, the electrode may be subjected to secondary anodization to enhance the binding between the nanotube array and substrate. During manufacture the electrode may be processed with ethanol to reduce cracks in the nanotube array. Additionally, during electrolysis the voltage polarity applied the electrode may be periodically switched so that the electrode operates alternatively as an anode or a cathode depending on the voltage polarity.

### CROSS REFERENCE TO RELATED APPLICATIONS

This Application claims the benefit of U.S. Provisional Patent Application Ser. No. 62/401,377, filed on Sep. 29, 2016, which is incorporated by reference herein in its entirety.

### TECHNICAL FIELD

The present invention generally relates to electrolysis, and more particularly, to electrodes for water treatment electrolysis.

### BACKGROUND

Systems are being proposed for the electrochemical oxidation of pollutants in an electrolyte. Examples of these systems include wastewater treatment systems that employ electrolysis to clean wastewater. These systems apply a voltage potential between an anode and a cathode that are each in contact with the wastewater to achieve electrochemical oxidation of organic matter.

The electrodes (anodes and cathodes) in these systems sometimes have one or more semiconductor materials that contact the wastewater. The semiconductor electrodes are often composed of expensive rare earth materials. Moreover, the semiconductor materials often degrade during operation of the systems, reducing the service life of the electrodes.

Additionally, another problem with known electrodes is that they may also cause undesirable levels of foaming or scaling during electrolysis of wastewater.

Further, the ability of some of the electrodes to purify water depends on the ability of the anode to generate Reactive Chlorine Species (RCS) and/or hydroxyl radicals in the water. However, some known electrodes generate reactive species at current efficiencies that are too low to be desirable for some wastewater treatment applications.

Accordingly, electrolysis electrodes are desirable that have increased service life and current efficiency, as well as reduced cost, foaming and scaling.

### SUMMARY

An electrolysis electrode with improved chlorine evolution and hydroxyl radical production activity is disclosed. The electrode includes a substrate, a nanotube array having a bottom surface contacting the substrate, and a semiconductor layer contacting the top surface of the nanotube array. This structure improves the performance and service life of the electrode in wastewater treatment applications.

In accordance with an exemplary embodiment of the electrode, the nanotube array may include a stabilized blue-black TiO₂ nanotube array (BNTA), the semiconductor layer may include titanium dioxide, and the substrate may be titanium.

The electrode may be manufactured by synthesizing the nanotube array on the substrate by anodic oxidation of the substrate, and depositing a semiconductor layer on the nanotube array using spray pyrolysis.

The electrode can be used in systems that purify water having organic pollutants and/or ammonia by placing it in direct physical contact with the wastewater and applying a suitable voltage potential.

The disclosure also describes a water purification system including one or more electrodes where at least one of the electrodes has a substrate, a nanotube array having a bottom surface contacting the substrate, and a semiconductor layer contacting the top surface of the nanotube array.

The foregoing summary does not define the limits of the appended claims. Other aspects, embodiments, features, and advantages will be or will become apparent to one with skill in the art upon examination of the following figures and detailed description. It is intended that all such additional features, embodiments, aspects, and advantages be included within this description and be protected by the accompanying claims.

### BRIEF DESCRIPTION OF THE FIGURES

It is to be understood that the drawings are solely for purpose of illustration and do not define the limits of the appended claims. Furthermore, the components in the figures are not necessarily to scale. In the figures, like reference numerals designate corresponding parts throughout the different views.

FIGS. 1A-B illustrate an exemplary electrolysis system employing the electrode.

FIG. 2 illustrates a second exemplary electrolysis system such as a continuous water purification system.

FIG. 3 is a schematic perspective view showing an electrode of FIGS. 1 and 2.

FIG. 4 is a schematic cross-sectional view showing an electrode of FIGS. 1 and 2.

FIGS. 5A-B are schematic illustrations of the electronic band structures of NTA, BNTA and aged BNTA.

FIGS. 6A-B are field emission scanning electron microscope (FESEM) images of the surface of an exemplary electrode.

FIGS. 7A-B are FESEM images of the nanotube array of an exemplary electrode.

FIG. 8 is a FESEM image of an exemplary electrode showing the enhanced contact between the substrate and the nanotube array.

FIG. 9 is a FESEM image of an exemplary electrode showing the top layer overlaying the nanotube array.

FIG. 10 is a graph comparing the .OH generation for each of the tested electrodes.

FIG. 11 is a graph comparing the chlorine evolution rate and current efficiency of the disclosed electrode with prior electrodes.

FIGS. 12A-C are graphs showing example experimental results of chlorine radical generation during electrolysis using the disclosed electrode.

FIGS. 13A-D are graphs comparing the experimental results of wastewater treatment using the disclosed electrode and prior electrodes.

FIGS. 14A-B are graphs comparing the formation of ClO₃⁻ and ClO₄⁻ in the course of experimental human wastewater electrolysis using the disclosed electrode and prior electrodes.

FIGS. 15A-C are graphs comparing the removal of Ca²⁺ and Mg²⁺ during experimental human wastewater electrolysis using the disclosed electrode and prior electrodes.

### DETAILED DESCRIPTION

The following detailed description, which references to and incorporates the drawings, describes and illustrates one or more examples of electrolysis electrodes, water treatment systems, and methods of using electrolysis electrodes and water treatment systems, and of manufacturing electrolysis electrodes. These examples, offered not to limit but only to exemplify and teach embodiments of inventive electrodes, methods, and systems, are shown and described in sufficient detail to enable those skilled in the art to practice what is claimed. Thus, where appropriate to avoid obscuring the invention, the description may omit certain information known to those of skill in the art. The disclosures herein are examples that should not be read to unduly limit the scope of any patent claims that may eventual be granted based on this application.

The word “exemplary” is used throughout this application to mean “serving as an example, instance, or illustration.” Any system, method, device, technique, feature or the like described herein as “exemplary” is not necessarily to be construed as preferred or advantageous over other features.

As used in this specification and the appended claims, the singular forms “a,” “an,” and “the” include plural referents unless the content clearly dictates otherwise.

Although any methods and materials similar or equivalent to those described herein can be used in the practice or testing of the invention(s), specific examples of appropriate materials and methods are described herein.

Also, the use of “or” means “and/or” unless stated otherwise. Similarly, “comprise,” “comprises,” “comprising” “include,” “includes,” and “including” are interchangeable and not intended to be limiting.

It is to be further understood that where descriptions of various embodiments use the term “comprising,” those skilled in the art would understand that in some specific instances, an embodiment can be alternatively described using language “consisting essentially of” or “consisting of.”

Water scarcity has been recognized as an emerging global crisis. In order to facilitate water recycling and reuse, decentralized wastewater treatment has been proposed as a supplement to the conventional urban wastewater system. In decentralized systems, electrochemical oxidation (EO) can be more efficient than biological treatment and less expensive than homogeneous advanced oxidation processes. In addition, the compact design, ease of automation for remote controlled operation, and small carbon footprint make EO an ideal candidate for small scale, decentralized wastewater treatment and reuse.

The performance of EO in wastewater applications is often determined by the electrochemical generation of reactive species, which largely depends on the nature of anode materials. A number of anode materials have been previously considered. For example, non-active anodes with high overpotentials for oxygen evolution reaction (OER), such as those based on SnO₂, PbO₂, and boron-doped diamond (BDD), have been investigated in the previous decades. In spite of their superior current efficiency for hydroxyl radical (.OH) generation, SnO₂ and PbO₂ anodes have poor conductivity and stability. The application of BDD anodes is hindered by their high cost and complicated fabrication. Conversely, Pt-group metal oxides (e.g., RuO₂ and IrO₂) are efficient and stable catalysts for OER, exhibiting high chlorine evolution reaction (CER) activity in the presence of chloride, although they are typically less efficient for hydroxyl radical generation. Hence, the development of durable anodes with high activity for both CER and radical generation is an ongoing challenge.

Electrolyte composition is another factor in EO performance. Previously, .OH was considered as the main contributor to organic matter removal during EO. Recent studies have pointed out that carbonate, sulfate and phosphate radicals are also potent oxidants. Compared with these anions, chloride (Cl—) in wastewater can be more readily oxidized to reactive chlorine species. Enhanced electrochemical oxidation of organic compounds observed in the presence of Cl— has been attributed to reaction with free chlorine (Cl₂, HOCl and OCl⁻. More recent studies have suggested that Cl. and Cl₂.⁻ might be primarily responsible for organic compound degradation. Thus, an anode that promotes efficient generation of chlorine radicals may be desirable.

Applications of electrochemical wastewater treatment can be hindered by several challenges, which may include: 1) relatively high energy consumption costs per kilogram of chemical oxygen demand (COD) treated in units of kWh/kg of COD, depending on the composition of the electrodes; 2) foam formation and scale deposition on the electrode surfaces; 3) lack of control of undesirable byproduct formation; and 4) the relatively high cost of semiconductor electrodes due to the use of platinum group metals as the primary ohmic contact materials for transfer of electrons to the base metal.

Considering each of these challenges more specifically, the energy consumption of EO wastewater treatment processes (50-1000 kWh/kg COD) may be higher than aerobic biological treatment (3 kWh/kg COD; assuming 320 g/m³ of inlet COD, 50% of removal efficiency, and 0.45 kWh/m³ of energy consumption per volume). Foaming, which is due both to the gas evolution and the presence of naturally-occurring and artificial surfactants in wastewater may reduce electrochemical treatment efficiency by blocking active sites on the electrode surfaces. In addition, the accumulation of foam in the reactor headspace above the electrochemical electrode arrays may result in corrosion of the electrical connections. The spillover of foam may also cause secondary pollution of the treatment site. Scaling, which is due to the cathodic forcing of the precipitation of Ca²⁺ and Mg²⁺, is also undesirable since it also reduces treatment efficiency and reduces the reactive interfacial surface areas. Electrolysis of chloride-containing wastewater produces chlorination byproducts such as chlorate (ClO₃⁻) and perchlorate (ClO₄⁻). Anodes operating at higher oxidative levels are often able to eliminate organic compound byproducts at longer reaction times, however with the tradeoff of higher yields of ClO₃⁻ and ClO₄⁻. Currently available electrodes are relatively expensive due to the need to provide a low Schottky-barrier semiconductor in direct contact with the base-metal support of the electrode. For active electrodes, IrO₂ or RuO₂ are employed as ohmic contacts, and for nominally inactive electrodes, boron-doped diamond electrodes (BDD) are employed.

To address the foregoing challenges, an electrolysis electrode featuring a stabilized nanotube array (NTA) is disclosed. The disclosed NTA electrode can be applied in EO wastewater treatment system as described herein.

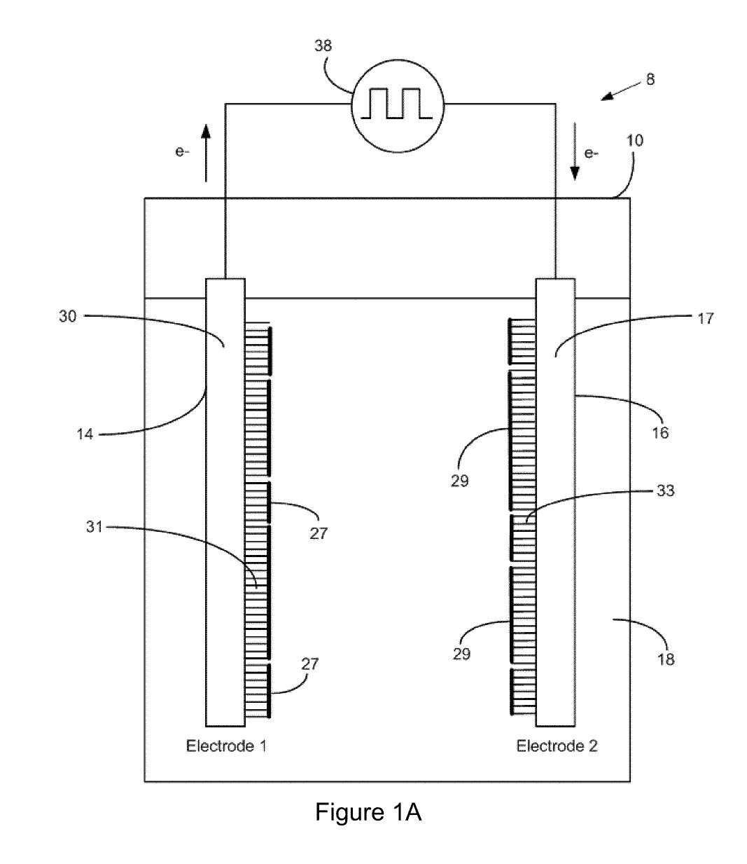

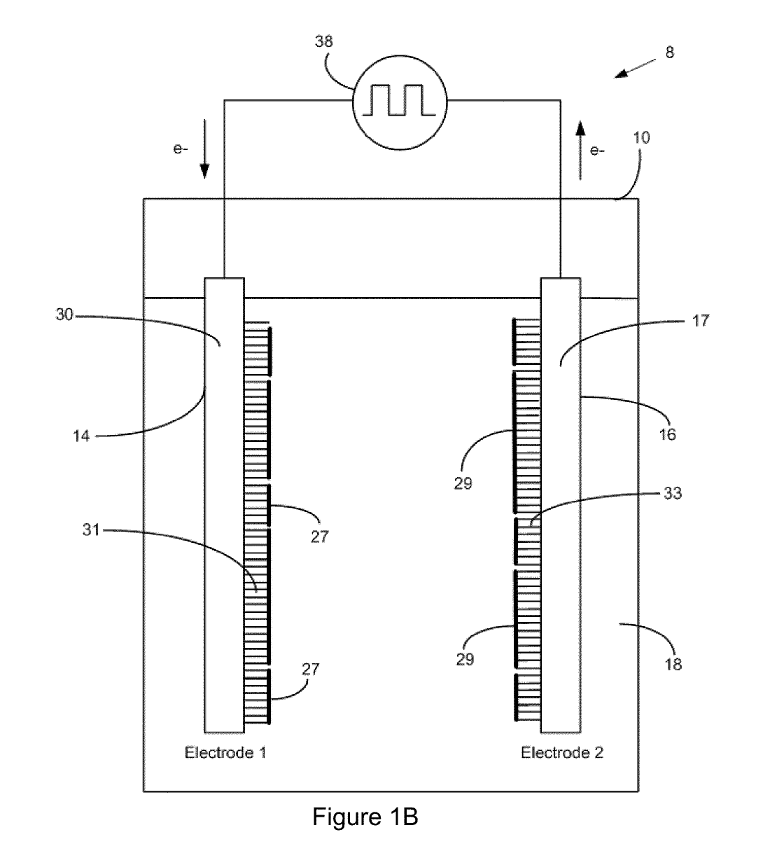

FIG. 1A is a simplified illustration of a water purification system 8 that includes a vessel 10 for holding an electrolytic medium 18 such as wastewater, a first electrode (electrode 1) 14 and second electrode (electrode 2) 16 for use in a wastewater electrolysis, and a voltage source 38 for providing current to the electrodes 14, 16. The system 8 can purify water having organic matters by making use of advanced oxidation processes (AOP) to break organic matters into small and stable molecules, such as water and CO₂. For the purposes of simplification, only a pair of electrodes 14, 16 are illustrated, although additional electrodes 14, 16 can be employed in the same or separate vessels in series or parallel.

The system 8 can operate in a monopolar (MP mode) or a bipolar (BP) mode. In MP mode, the voltage source 38 provides continuous current between the electrodes 14, 16 in one direction and does not switch voltage polarity (reverse the direction of the current flow through the electrodes 14, 16). In the example shown in FIG. 1A, in MP mode the first electrode 14 acts as an anode and the second electrode 16 acts as a cathode. In this case, the second electrode 16 can be a metal base, such as a stainless steel or platinum cathode, instead of the structure of the electrode 16 shown in FIG. 1A.

In BP mode, each of the electrodes 14, 16 can act as either an anode or a cathode, alternatively, depending on the polarity of the voltage source 38. In the example shown in FIG. 1A, the current flow from source 38 is such that the first electrode 14 is acting as an anode and the second electrode 16 is acting a cathode. FIG. 1B shows the same system 8 with the voltage source 38 polarity reversed so that the first electrode 14 is a cathode and the second electrode 16 is an anode. Operating the system 8 in BP mode can increase the service life and improve the performance of the electrodes 14, 16.

The voltage source 38 can switch polarity at a set frequency so that the electrodes 14, 16 are alternatively employed as both anode and cathode. Switching the polarity of the source 38 can be accomplished by a timed switch in the source 38 that changes the output voltage polarity of the source 38 at set times. For example, the electrodes 14, 16 can be employed as both anode and cathode with source polarity switching at an interval having a length between 10 and 30 minutes.

The water purification system 8 can be used to purify wastewater. Wastewater includes the organic matters that are normally associated with waste products and chloride that is naturally present in urine. Accordingly, wastewater can naturally operate as the electrolytic medium 18 or an electrolyte, such as NaCl, can optionally be added to the wastewater.

Examples of the detailed construction of the electrodes 14, 16 are described herein with reference to the other Figures. Generally, the electrode 14 includes a substrate 30, a nanotube array 31 having a bottom surface contacting the substrate 30, and a semiconductor layer 27 contacting the top surface of the nanotube array 31. Similarly, the electrode 16 includes a substrate 17, a nanotube array 33 having a bottom surface contacting the substrate 17, and a semiconductor layer 29 contacting the top surface of the nanotube array 33. This structure improves the performance and service life of the electrodes 14, 16 in wastewater treatment applications.

In accordance with an exemplary embodiment of the electrodes 14, 16, the nanotube arrays 31, 33 may each include a stabilized blue-black TiO₂ nanotube array (BNTA), the semiconductor layers 27, 29 may each include titanium dioxide, and the substrates 17, 30 may be titanium foil.

During operation of the water purification system 8, the source 38 applies an anodic potential 38 between the first electrode 14 and the second electrode 16 at a level that is sufficient to generate reactive species at the electrode 14, 16 presently performing as an anode.

The electrodes 14 have a relatively high rate of Reactive Chlorine Species (RCS) generation and other reactive species generation. This makes the electrodes 14, 16 highly suitable for use in wastewater electrolysis systems.

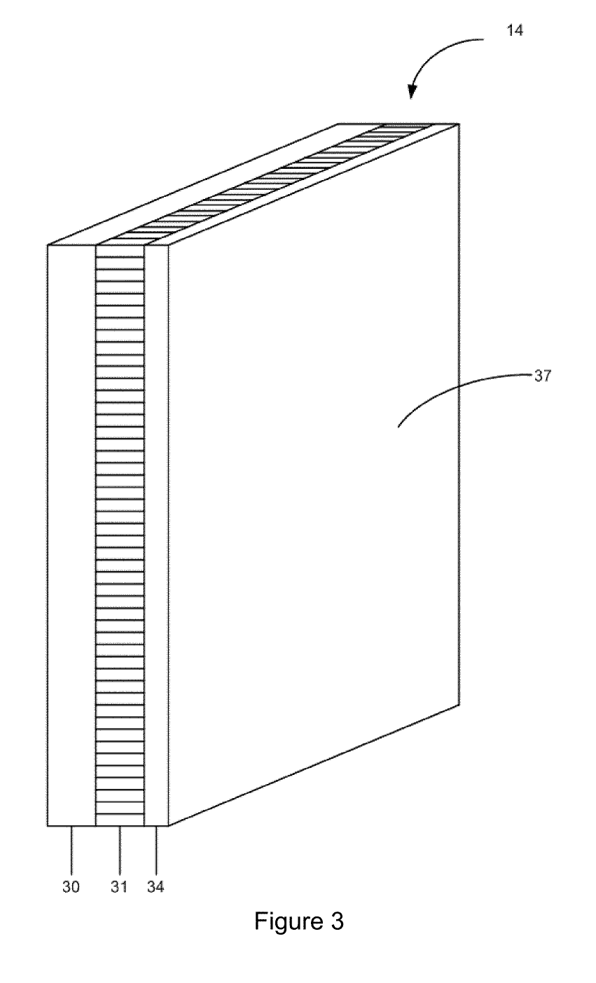

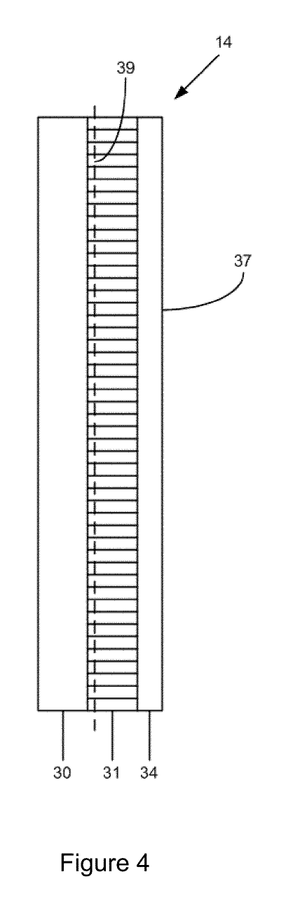

The example semiconductor layers 27, 29 shown in FIGS. 1A-B are discontinuous in that they have gaps in their top surfaces. In some embodiments, these gaps may not be present and the layers 27, 29 may be continuous. An example of a continuous semiconductor top layer 34 is illustrated in FIGS. 3 and 4 herein.

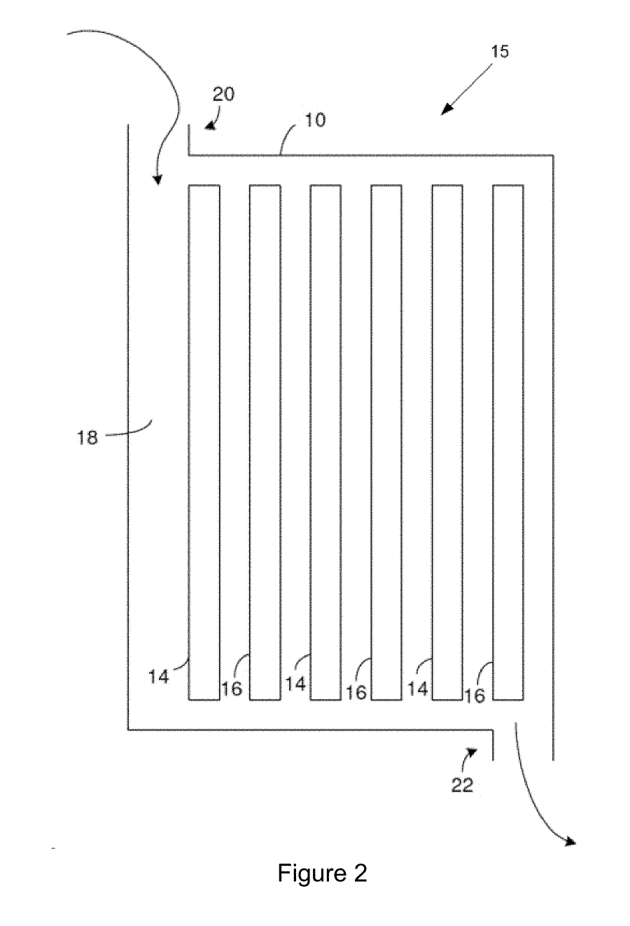

FIG. 2 illustrates an example of another suitable electrolysis system 15 such as a water purification system that includes multiple first electrodes 14 and second electrodes 16. The system 15 includes a vessel 10 having a reservoir. First electrodes 14 and second electrodes 16 are positioned in the reservoir such that first electrodes 14 and second electrodes 16 alternate with one another. The first electrodes 14 and second electrodes 16 are parallel or substantially parallel with one another. An electrolytic medium 18 is positioned in the reservoir such that first electrodes 14 and the second electrodes 16 are in contact with the electrolytic medium 18. The electrolytic medium 18 includes one or more electrolytes and can be a liquid, a solution, a suspension, or a mixture of liquids and solids. In one example, the electrolytic medium 18 is wastewater that includes organic matters, ammonia, and chloride (Cl⁻). The chloride can be present in the electrolytic medium 18 as a result of adding a salt to the electrolytic medium 18 or the electrolytic medium 18 can include urine that is a natural source of the chloride. The electrolysis system 15 also includes a voltage source configured to drive an electrical current through the first electrodes 14 and second electrodes 16 so as to drive a chemical reaction in the electrolytic medium 18. The system 15 can operate in MP mode or alternatively in BP mode.

The electrolysis system 15 illustrated in FIG. 2 includes an inlet 20 and an outlet 22. The electrolysis system 15 can operate as a continuous reactor in that the electrolytic medium 18 flows into the reservoir through the inlet 20 and out of the reservoir through the outlet 22. Alternately, the electrolysis system can also be operated as a batch reactor. When the electrolysis system 15 is operated as a batch reactor, the electrolytic medium 18 can be a solid, a liquid, or a combination.

FIG. 3 is a schematic perspective view of an example construction of the first electrode 14. The second electrode 16 can be similarly constructed. The electrode 14 includes a substrate 30 such as a metal base, a nanotube array (NTA) 31 having a bottom surface contacting the substrate 30, and a semiconductor layer 34 contacting the top surface of the nanotube array 31. The exposed surface 37 of the semiconductor layer 34 contacts the electrolyte during electrolysis. According to an exemplary embodiment, the electrode 14 may be a Ti/EBNTA electrode, as described herein below.

Suitable materials for the substrate 30 include valve metals, such as Ti.

The nanotube array 31 can include, consist of, or consist essentially of any suitable number of nanotubes and a metal oxide that includes, consist of, or consist essentially of oxygen and one or more elements, e.g., titanium. For example, the NTA may be a blue-black TiO₂ nanotube array (BNTA).

The semiconductor layer 34 can include, consist of, or consist essentially of a metal oxide that includes, consist of, or consist essentially of oxygen and one or more elements, such as titanium. For example, the semiconductor layer 34 may be a TiO₂ layer deposited on the NTA 31 by spray pyrolysis.

FIG. 4 is a schematic cross-sectional view of the electrode 14. This view shows the enhanced attachment region 39 between the substrate 30 and NTA 31 created by an extended anodization during manufacture of the electrode, as described below.

The invention may also be illustrated by the following examples, which are provided by way of illustration and are not intended to be limiting.

### EXAMPLES

### Example 1

An electrode having a blue-black TiO₂ nanotube array (BNTA) stabilized by a protective over-coating with nano-particulate TiO₂ (Ti/EBNTA electrode) was prepared for use as electrodes 14, 16. Accordingly, the Ti/EBNTA electrode can be applied in the EO wastewater treatment systems as described herein. Other electrode types were prepared or obtained for comparative testing against the Ti/EBNTA electrode.

The example electrodes described herein were characterized by field emission scanning electron microscope (FESEM, ZEISS 1550VP), X-ray photoelectron spectroscopy (XPS, Surface Science M-Probe ESCA/XPS), and Diffuse reflectance UV-Vis spectrophotometer (UV-Vis, SHIMADZU UV-2101PC). Cyclic voltammetry (CV) and electrochemical impedance spectroscopy (EIS) were measured using a Biologic VSP-300 potentiostat. To obtain Mott-Schottky plots, EIS analyses were conducted at anodic potentials of 0-1.1 V_{RHE} with frequency ranges from 1 to 100 kHz.

Efficient, inexpensive, and stable electrode materials are desirable components of commercially-viable EO wastewater treatment systems. As described herein, BNTA electrodes are prepared by electrochemical self-doping. The 1-D structure, donor state density, and Fermi energy level position for maintaining the semi-metallic functionality of the BNTA are also described. The structural strength of the BNTA may be enhanced by surface crack minimization, reinforcement of the BNTA-Ti metal substrate interface, and stabilized by a protective over-coating with nano-particulate TiO₂ (Ti/EBNTA electrode).

The Ti/EBNTA electrodes may be employed as both anodes and cathodes with polarity switching at a set frequency, as described in connection with FIGS. 1A-B. Oxidants are generated at the anode, while the doping levels are regenerated along with byproduct reduction at the cathode. The estimated maximum Ti/EBNTA electrode lifetime is 16895 hours, which is a substantial improvement. The example Ti/EBNTA electrode was experimentally measured to have comparable hydroxyl radical production activity (6.6×10⁻¹⁴ M) with boron-doped diamond (BDD, 7.4×10⁻¹⁴ M) electrodes. The chlorine production rate follows a trend with respective to electrode type of Ti/EBNTA>BDD>IrO₂. The Ti/EBNTA electrodes operated in a bipolar (BP) mode (periodically switched voltage polarity) showed a minimum energy consumption of 62 kWh/kg COD, reduced foam formation due to less gas bubble production, reduced scale formation, and lower chlorate production levels (6 mM vs. 18 mM for BDD) during experimental electrolytic wastewater treatment.

In order to lower the cost of electrode production, research has been focused on modification of a titanium (Ti) metal base to produce an anode that is active for wastewater treatment. However, the exposed surface of Ti metal is easily oxidized to produce a passive layer of TiO₂ during anodic polarization. Titanium base-metal surfaces that are oxidized into nanotube arrays (NTAs) are typically relatively inactive as anodes. However, the conductivity of NTA can be improved by cathodization in an aqueous electrolyte at room temperature. After cathodization, the color of NTA turns from gray to blue-black. The chlorine evolution activity of blue-black NTA (BNTA) is comparable to that of IrO₂ and BDD anodes. The production of hydroxyl radical (.OH) on BNTA is supported by the electrochemical degradation of p-nitrosodimethylaniline (though the direct electron transfer mechanism cannot be excluded). However, the previously reported active lifetimes of BNTA anodes range from a few minutes to several hours before inactivation.

Techniques of activation and deactivation of BNTA and methods to improve the structural stability of BNTA are described herein below. An EO operational method that used a BP mode is also disclosed that increases the lifetime of BNTA in electrochemical oxidant generation and wastewater treatment.

BNTA can be synthesized by electrochemical cathodization of TiO₂ nanotube array. However, under positive potential bias, conventional BNTA has poor active lifetimes, which range from a few minutes to several hours.

Four techniques are disclosed herein to enhance service lives of electrodes featuring BNTA in electrolysis applications. First, ethanol may be used instead of water as a rinsing solution to minimize crack on BNTA film during manufacture. Second, BNTA can be subjected to a secondary anodization during manufacture to enhance the binding between nanotube array 31 and the substrate 30. Third, a thin layer (e.g., 100 nm thickness, mass loading of 5 mg/cm²) of a semiconductor material, such as TiO₂, can be deposited onto BNTA as a protective layer. Fourth, TiO₂ over-coated enhanced BNTA electrodes (Ti/EBNTA electrodes) can be employed as both anode and cathode with polarity switching at a set frequency in BP mode operation. Using the above approaches may significantly prolong the lifetimes of Ti/EBNTA electrodes.

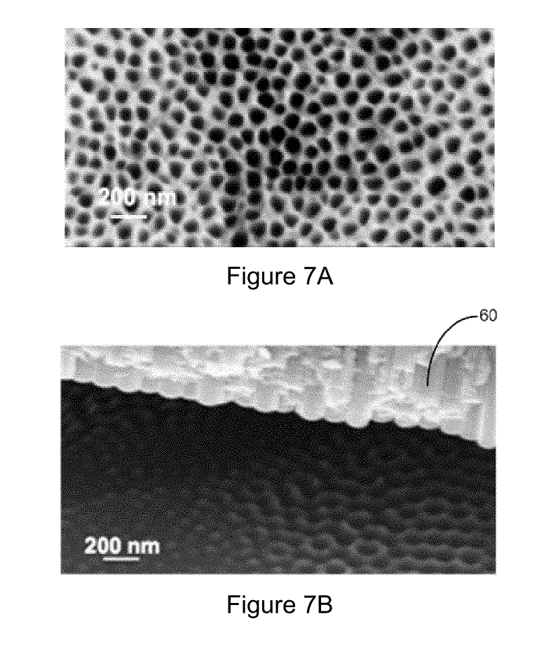

To manufacture the Ti/EBNTA electrode, a TiO₂ NTA film was synthesized by anodic oxidation of titanium foil (e.g., area of about 6 cm²) at a constant voltage of 42 V in an ethylene glycol (EG) electrolyte containing 0.25 wt % NH₄F and 2 wt % H₂O for between three to six hours. FIGS. 7A-B are FESEM images (FIG. 7A is a top down view and FIG. 7B is a perspective view) of the nanotube array 60 of an example electrode. The Ti foil serves as the substrate. NTA with tube lengths of 10 and 16 μm may be prepared after three hours and six hours of anodization, respectively. The Ti/EBNTA electrode of the examples described herein use 16 μm average NTA tube lengths. To structurally enhance the NTA film after anodization in the NH₄F electrolyte, the NTA-filmed electrode was subjected to secondary anodization in 5 wt % H₃PO₄/EG electrolyte at an applied potential of 42 V for one hour. The electrode was then rinsed with ethanol, dried in vacuum, followed by calcination in 450° C. for 1 hour.

Following calcination, a TiO₂ protective layer was deposited on top of the TiO₂ nanotube array by spray pyrolysis. Using spray pyrolysis, an aqueous metal oxide precursor was atomized with 5 psi air and sprayed onto the heated (e.g., 300° C.) BNTA electrode. The resulting oxide film was then annealed at 450° C. for 10 minutes. This procedure was repeated to reach the desired mass loading for the semiconductor layer. The TiO₂ precursor contained 25 mM titanium-glycolate complex prepared by a hydroxo-peroxo method. To do this, 8.5 mL titanium butoxide was gradually added into 50 mL deionized water with pre-dissolved 2.85 g glycolic acid. Then 40 mL 35% H₂O₂ was added into the above solution with the rate of 0.5 mL/min. Finally, 3 mL ammonium hydroxide was added to adjust the pH to circumneutral.

The electrode was then cathodized in a 1 M NaClO₄ solution at a current density of 5 mA/cm² for 10 min. An EBTNA with a TiO₂ over-coating layer is denoted herein as Ti_{0.5}/EBTNA or Ti₁/EBTNA, where the subscript represents the mass loading (mg/cm²) of the TiO₂ over-coating layer.

During cathodization a variable number Ti(IV) sites within NTA are electrochemically reduced to Ti(III). The effective loss of charge is compensated by H⁺ intercalation. Valence-band XPS measurements showed that cathodization of the NTA creates conduction band tail states (a relative 0.1 eV shift) in the BNTA. This effect appears to lead to a disordered TiO₂ structure. DRUV-Vis characterization showed that the BNTA has a stronger red and infrared absorption level than NTA, but the band-gap of BNTA (3.3 eV) is slightly larger than that of the NTA (3.2 eV). Therefore, the cathodization-induced color change cannot be explained simply by band gap narrowing, but could be attributed to the formation of continuous dopant states. The resulting dopant states can be assigned to the Ti(III) centers located at energies between 0.3-0.8 eV below conduction band.

The increase of conductivity of BNTA is not due to band gap narrowing. In contrast, the position of Fermi energy level (E_{F}) actually determines the conductivity of semiconductor. If the donor state densities (N_{D}) are very high, then the E_{F} will be located above the conduction band edge (E_{C}), resulting in a degenerately-doped n-type semiconductor with a semi-metallic character. Flat-band potentials (E_{FB}) were measured as an indirect measure of E_{F}. It was experimentally determined that the E_{FB} shifts from 0.35 V for NTA to −0.29 V for BNTA, accompanied with the sharp increase of N_{D} (4.43×10¹⁹ and 2.79×10²⁶ cm⁻³ for NTA and BNTA, respectively). The shift of E_{FB} implies the shift of E_{F}.

Calculations show that the E_{F} of BNTA is above the E_{C}; thus, BNTA can be classified as a degenerately-doped TiO₂. For example, the Fermi level (E_{F}) of n-type semiconductor can be approximately treated as the conduction band edge, and flat band potential (E_{FB}) is equal to E_{F}. It is known that the E_{F} of NTA is 0.35 V_{SHE}, which can be considered as the conduction band edge (E_{C}). By adding the 3.2 eV band-gap to E_{C}, the valence band edge E_{V} of NTA is determined as 3.65 V_{SHE}. Knowing that there is a 0.1 eV shift of E_{V}, the E_{V} of BNTA is determined as 3.55 V_{SHE}. The E_{C} of BNTA is obtained by adding 3.3 eV band gap to E_{V}, which is 0.25 V_{SHE}.

In this case, the states between E_{F} and E_{C}are mostly filled with electrons, thus the conduction band has relatively large electron concentration, resulting in the marginal increase of conductivity. The 1-D structure of BNTA nanotubes is found to maintain the degenerate state. Typical TiO₂ films do not yield a current response in the anodic branch of CV even after cathodization. While BNTA with tube lengths of 10 μm or 16 μm have a significant current response above 2.7 V_{RHE} for which the current densities are proportional to the tube length. In the case of the TiO₂ films, the excited-state hole most likely oxidizes the bulk-phase Ti(III) centers as a relaxation pathway. After excitation, the BNTA structure allows for facile hole transport from the bulk-phase to the surface of tube walls. This feature preserves the bulk Ti(III) centers for longer periods of time.

CV analyses showed that the BNTA electrode has higher overpotentials for oxygen evolution and hydrogen production than the reference state Ti/Ir electrodes. The onset potential of BNTA (2.81 V_{RHE}) are similar to that of BDD (2.88 V_{RHE}), except that the maximum current response of the former is ten-fold higher. This feature indicates a higher electrochemical activity for the BNTA.

However, the lifetimes of the initial BNTA were determined to be three hours at 10 mA/cm² and 30 min at 20 mA/cm². Deactivation was observed when anodic potentials exceeded 5 V_{SHE}. Thus, the deactivation of the unprotected BNTA can be ascribed to the oxidation of Ti(III) centers at high applied anodic potentials. However, the deactivated (i.e., aged) BNTA maintained a considerable doping level of N_{D}=3.84×10²⁵ cm⁻³ and an E_{F} located above E_{C}.

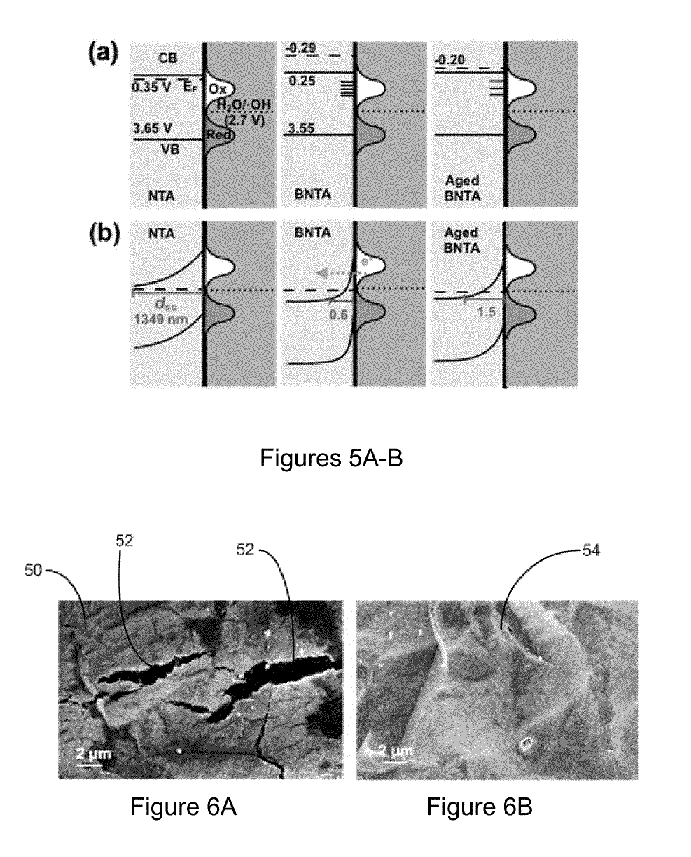

In order to explain the electrochemical activity of the BNTA, an electron tunneling mechanism can be invoked. At an anodic potential of +2.7 V_{SHE}, which is sufficient potential for hydroxyl radical generation, on an n-type semiconductor, band bending will produce a space charge layer at the solid-water surface. This is illustrated in FIG. 5B, which shows the positions of conduction band (CB), valence band (VB), and Femi energy level (E_{F}), with band bending at 2.7 V_{NHE} that creates space charge layers with the width of d_{SC}. The width of space charge layer (d_{SC}), which is a function of anodic potential, E_{F}, and N_{D}, is calculated to be 1349, 0.6, and 1.5 nm for NTA, BNTA, and aged BNTA, respectively (FIG. 5B). The d_{SC} for NTA is too large for electron penetration as tunneling can only happen at d_{SC}<1-2 nm. Given this limit, BNTA has the highest electron tunneling probability, while that of aged BNTA is significantly lower due to a longer d_{SC}. The electron tunneling mechanism is consistent with experimental observations. This mechanism also explains the importance of maintaining a high value of N_{D}.

The lifetime of BNTA may be enhanced by periodically increasing the depleted levels of N_{d}. For example, the BNTA could be used both as anodes and cathodes by operating in the BP mode, in which the polarity is reversed at a given intervals. Consequently, this approach requires BNTA to have sufficient stability in both anodic and cathodic cycles. Also, the structural strength of the attached BNTA is a factor determining the lifetime.

In order to improve the structural strength of the BNTA, three nano-fabrication strategies were employed. First, cracks in the surface of the NTA films were minimized. Cracks 52 are visible on surface 50 of freshly prepared NTA (FIG. 6A). The cracks 52 were formed as the result of capillary forces generated by the high surface tension (72 mN/m) of water during synthesis, rinsing and drying processes of preparing the NTA electrode. The cracks 52 on the surface 50 expose the bottom portion of the NTA attached to the substrate 30 to gas evolution reactions, which may lead to erosion and the subsequent detachment of NTA films. A reduction in the occurrence of cracks in the NTA films (FIG. 6B) was achieved by replacing water with ethanol (22 mN/m) for rinsing during the manufacturing process. The NTA film was then vacuum dried instead of heat dried.

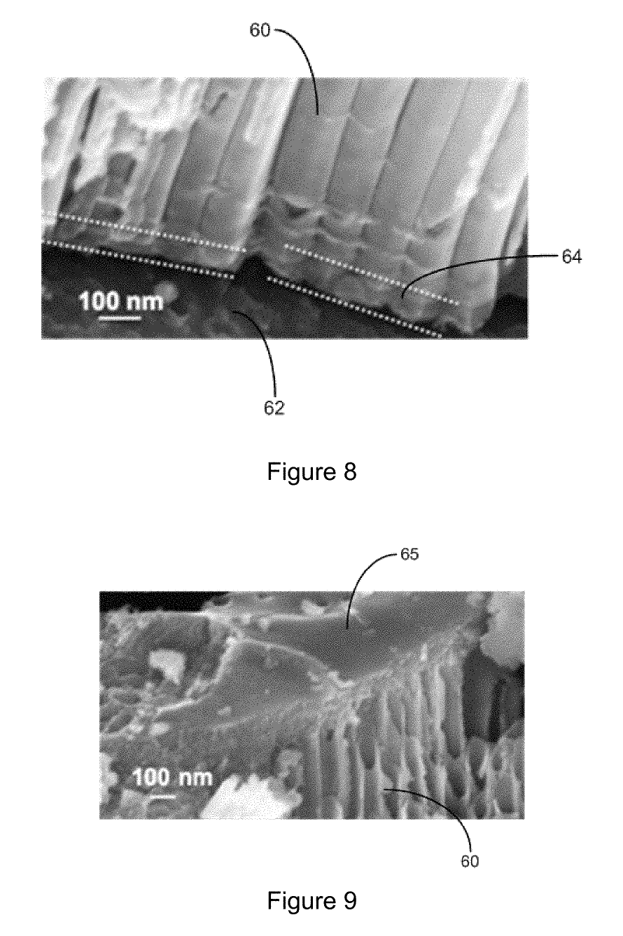

Second, the bottom attachment points of NTA were enhanced, as illustrated in FIG. 4. The presence of a fluoride-rich bottom layer of BNTA most often results in poor adhesion to the metal substrate. Extended anodization in fluoride-free electrolyte results in the formation of a dense, compacted layer near the bottom attachment points of the nanotubes to the titanium substrate (Region 39 of FIG. 4). For the Ti/EBNTA electrode that was prepared, this is shown in the FESEM image of FIG. 8. The NTA 60 includes a compacted layer 64 near its bottom at the attachment region with the substrate 60.

Third, the tops of the NTA were capped with a protective TiO₂ layer that was deposited using a spray-pyrolysis coating procedure with precise control of the loading of the amount of TiO₂ deposited as protective top layer. FIG. 9 is a FESEM image of an exemplary Ti/EBNTA electrode showing the top layer 65 overlaying the nanotube array 60. At a loading level of 0.5 mg/cm², the deposited TiO₂ formed a porous layer, while at loading level of 1 mg/cm² produced compact film. Experiments showed that Ti_{0.5}/EBNTA had a higher current response than the untreated BNTA. The capping of NTA tips by the porous TiO₂ layer may prevent charge leakage at the tube tips during the cathodic doping process. More electrons were guided to reduce the Ti(IV) sites of tube wall, instead of being consumed by proton reduction at the tube tips. This resulted in a heavier doping of Ti_{0.5}/EBNTA than that of uncapped BNTA. The doping of Ti(IV) with TiO₂ to Ti(III) is accompanied by H⁺ intercalation to maintain charge neutrality. However, the compact TiO₂ layer of Ti₁/EBNTA appeared to block the access of bottom NTA to H⁺ intercalation. Thus, the current response of Ti₁/EBNTA was found to be even lower than that of untreated BNTA.

Overall, the stability of BNTA at 10 mA/cm² was improved by crack minimization and bottom layer enhancement. A lifetime test carried out at 20 mA/cm² showed that capping the nanotubes with a protective overcoat of TiO₂ further increased the stability of the EBNTA. Even though Ti_{0.5}/EBNTA was deactivated after four hours, layer detachment was not observed. Deactivation of Ti_{0.5}/BNTA is likely due to an increase in disorder of the tubular structure, which was induced by polarity switching. More defects in the structure may result in internal recombination and a loss of conductivity. The deactivated Ti_{0.5}/BNTA can be partially regenerated by re-annealing at 450° C. Reducing the regenerative self-doping frequency from 10 to a 30 min/cycle prolongs the operational lifetime. On the basis of the seven hour lifetime of Ti_{0.5}/BNTA measured at 20 mA/cm², the lifetime at actual operational current of 5 and 1 mA/cm² is estimated as 257 and 16895 hours, respectively.

### Example 2

The Ti/EBTNA electrode was experimentally tested by using it to perform electrolysis under controlled conditions using different electrolytes and also by applying it to electrochemically treat human wastewater. The testing also included comparisons with other type of electrodes. For example, commercially available BDD electrodes were obtained from Neocoat® for comparisons to the Ti/EBTNA electrode. IrO₂ electrodes with a TiO₂ overcoating (Ti/Ir) were also prepared by spray-pyrolysis for comparisons.

Electrolysis was performed under constant current conditions. In the monopolar (MP) mode, an anodic potential was applied in order to test the BNTA electrodes, which were coupled with Pt foil cathodes by a voltage source. In the bipolar (BP) mode, Ti/EBNTA electrodes were used as both anodes and cathodes. The polarity was reversed at a given interval, for example, at an interval between 10 and 30 minutes.

For wastewater treatments experiments, Chemical Oxygen Demand (COD) levels were determined using dichromate digestion (Hach Method 8000) and Total Organic Carbon (TOC) concentrations were determined using an Aurora TOC analyzer. Anions and cations were quantified by ion chromatography (ICS 2000, Dionex, USA).

Hydroxyl radical production was measured by using benzoic acid (BA) and p-benzoquinone (BQ) as probe molecules. The second-order rate constants for .OH with BA (k_{BA, .OH}) and BQ (k_{BQ, .OH}) are 5.9×10⁹ and 1.2×10₉ M⁻¹ s ⁻¹, respectively. The quasi steady-state concentration of .OH ([.OH]ₛₛ) in the electrolysis reaction is estimated according to the pseudo first-order rate constant for BA decay (k_{BA}) or BQ decay (k_{BQ}) in a 30 mM NaClO₄ electrolyte. (Eq. 1-2).

$$\begin{matrix}\frac{d [ BA ]}{dt} = {{k}_{BA , \cdot OH} [ BA ] [ \cdot OH ]}_{ss} = {k}_{BA} [ BA ] & ( Eq . 1 ) \\ {[ \cdot OH ]}_{ss} = \frac{{k}_{BA}}{{k}_{BA , \cdot OH}} & ( Eq . 2 )\end{matrix}$$

BA and BQ concentrations were determined by HPLC (1100) using a Zorbax XDB column with 10% acetonitrile and 90% 26 mM formic acid as an eluent.

Free chlorine concentrations ([FC]) were measured using the DPD (N,N-diethyl-p-phenylenediamine) reagent (Hach method 10102). The current efficiency of the electrode was estimated by the following equation:

$$η = \frac{2 VFd [ F C ]}{Idt} \qquad ( Eq . 3 )$$

where V is electrolyte volume (25 mL), F is the Faraday constant 96485 C mol⁻¹, I is the current (A).

BA and BQ were chosen as a .OH probes to measure oxidant generation. Given that direct electron transfer (DET) might also contribute to organic degradation, CV analyses were performed. If DET take places, an increase of current should be observed at the same anodic potential. However, this pathway is excluded on EBNTA as its CV was barely affected by the presence of BA. In contrast, DET by BA and BQ was observed on BDD. This could lead to an overestimation of [.OH]ₛₛ.

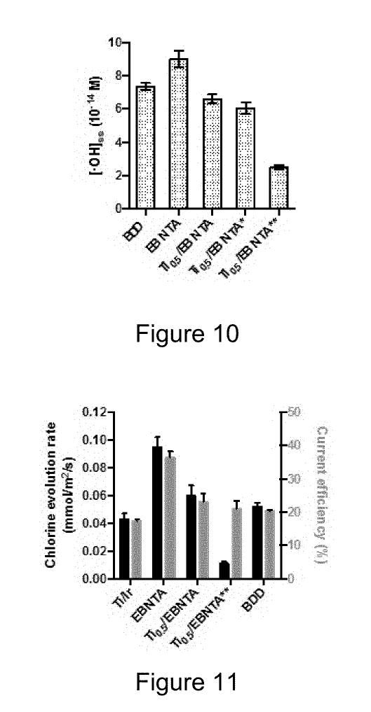

FIG. 10 is a graph illustrating comparative levels of .OH generation for each of the tested anodes. The [.OH]ₛₛ is estimated from 1 mM BA electrocatalytic degradation in 30 mM NaClO₄ at 5 mA/cm². [.OH]ₛₛ=k_{BA}/k_{.OH}. In the graphs of the Figures herein, * indicates that BQ was used as probe molecule in the electrolysis conducted at 5 mA/cm², and ** indicates that Ti_{0.5}/EBNTA was operated at 1 mA/cm².

As tested, the Ti/Ir anode was unable to produce .OH, since loss of BA was not observed. The EBNTA electrode had the highest value of [.OH]ₛₛ. The Ti_{0.5}/EBNTA anode was less active for .OH production than an EBNTA anode, but comparable to BDD electrode. The existence of .OH was confirmed again using BQ as a probe molecule. The [.OH]ₛₛ as measured by BQ degradation should be commensurate with that measured by BA degradation (Eq. 4), which was the case observed for the Ti_{0.5}/EBNTA anode.

$${[ \cdot OH ]}_{ss} = \frac{{k}_{BA}}{{k}_{BA , \cdot OH}} \approx \frac{{k}_{BQ}}{{k}_{BQ , \cdot OH}} \qquad ( Eq . 4 )$$

The Ti_{0.5}/EBNTA anode was able to produce .OH at a very low current density (1 mA/cm²). At a current density of 1 mA/cm², the gas evolution reactions (water splitting) were reduced significantly. The reduced gas formation rate results in a lower foam formation potential during wastewater electrolysis.

As shown in FIG. 11, the EBNTA electrode array has the highest selectivity and activity with respect to chlorine generation. The Ti_{0.5}/EBNTA was measured to have a lower chlorine evolution rate (CER) than an EBNTA electrode, but outperformed both the Ti/Ir and BDD electrodes in terms of CER. Even though a decrease in the current density to 1 mA/cm² resulted in the decrease in the CER of Ti_{0.5}/EBNTA, the current efficiency was much less impacted. This result indicates that Ti_{0.5}/EBNTA has good selectivity for chlorine evolution. The selectivity for the CER can be further enhanced by an increased [Cl³¹].

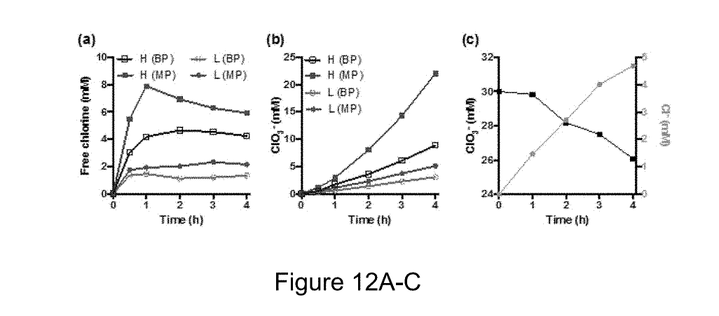

In spite of the higher activity for oxidant production observed with the EBNTA electrode, the Ti_{0.5}/EBNTA, which is more durable, could be better for practical engineering applications. In FIGS. 12A-C, four-hour NaCl electrolysis tests with an Ti_{0.5}/EBNTA electrode at current densities of 5 and 10 mA/cm² and operational modes, MP and BP, are presented. Free chlorine production and ClO₃⁻ evolution are observed, while the formation of ClO₄⁻ (detection limit: 1 ppb) was not observed. The concentrations of FC and ClO₃⁻ are proportional to current density. Electrolysis in the BP mode produces less Cl₂ and ClO₃⁻ than in the MP mode. These results indicate that use of the Ti_{0.5}/EBNTA cathode may contribute to the loss FC and ClO₃⁻. The Ti(III) centers are suspected to be the active sites for ClO⁻ and ClO₃⁻ reduction as follows:

Ti³⁺ClO⁻+2H⁺→Ti⁴⁺+Cl⁻+H₂O (Eq. 5)

6Ti³⁺ClO₃⁻+6H³⁰ →6Ti⁴⁺Cl³¹+3H₂O (Eq. 6)

The reduction of ClO₃⁻ to Cl⁻ on Ti_{0.5}/EBNTA cathode is confirmed by the data presented in FIGS. 12A-C.

The graphs of FIGS. 12A-C illustrate, respectively, the evolution of (a) free chlorine and (b) ClO₃⁻ in 30 mM NaCl as a function of electrolysis time at various current density (H: 10 and L: 5 mA/cm²); and (c) Reduction of ClO₃⁻ to Cl⁻ in 30 mM NaClO₃ at 10 mA/cm². In the testing depicted in FIGS. 12A-C, Pt foil was used as anode and a Ti_{0.5}/EBNTA electrode served as cathode. It was found that ClO₃⁻ gradually decreases accompanied with the increase of Cl⁻ concentration. This result indicates the reduction of ClO₃⁻ to Cl⁻ on Ti_{0.5}/EBNTA cathode.

### Example 3

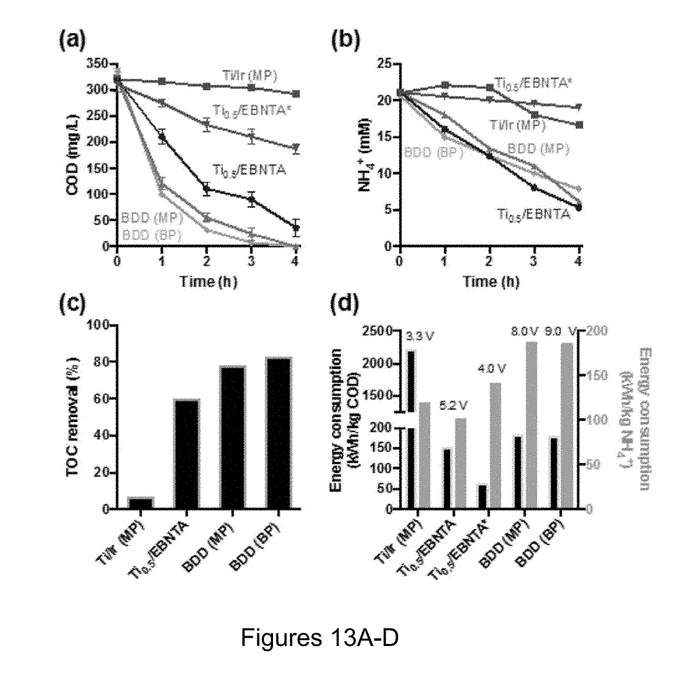

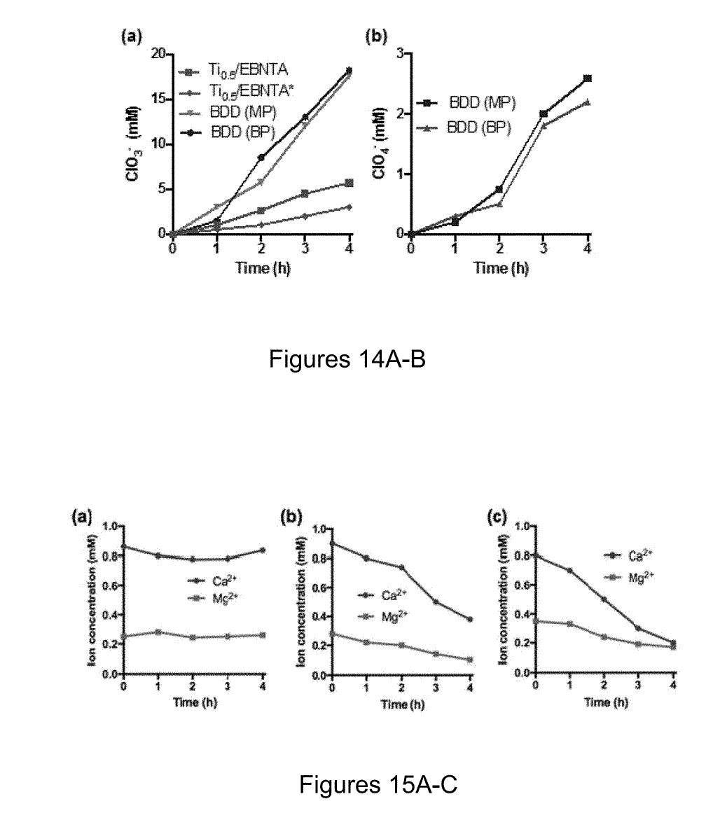

The Ti/EBTNA electrode was also tested in terms of its potential for domestic (e.g., human waste) wastewater treatment on a small scale. These tests were performed by comparatively testing the Ti/EBTNA electrode against various other electrodes for possible applications for human wastewater treatment. The observed trend for chemical oxygen demand (COD) reduction had the following order: BDD>Ti_{0.5}/EBNTA>Ti/Ir (FIG. 13A). This trend matches the corresponding .OH radical production activity. With respect to NH₄⁺ removal (FIG. 13B), BDD and Ti_{0.5}/EBNTA were found to be more active than Ti/Ir; this observation is in agreement with CER activity. Ammonium ion removal is achieved via breakpoint chlorination involving the self-reactions of the intermediate chloramines. BDD had the highest activity toward organic compound mineralization (i.e., conversion to CO₂ and H₂O); 80% of the initial TOC was removed from the wastewater (FIG. 13c). However, a substantial amount of ClO₃⁻ (18 mM) and ClO₄⁻ (3 mM) were formed during electrolysis with the BDD anode after four hours (FIG. 14). BDD electrodes were operated in BP mode to take advantage of the reduction activity of BDD cathode. Enhanced COD and TOC removal were found instead of the significant reduction of ClO₃⁻ and ClO₄⁻. This result implies that the hydrogen evolution and reduction of oxygen prevail at BDD cathode. The latter reaction most likely produces H₂O₂, which may contribute to organic removal. In the case of the Ti_{0.5}/EBNTA electrodes operated in the BP mode, less ClO₃⁻ (6 mM) was produced and no ClO₄⁻ was found after four hours. This implies that Ti_{0.5}/EBNTA operated in BP mode could effectively reduce the formation of chlorate.

As shown in FIG. 13D, using BDD as both anode and cathode requires a higher cell voltage. As a result, the BP mode did not show any advantages over MP mode in terms of specific energy consumption. The Ti_{0.5}/EBNTA electrode was found to be the most energy efficient among the electrodes tested. When the Ti_{0.5}/EBNTA anode was operated at 1 mA/cm², COD could be gradually removed even though the removal of NH₄⁺ was insignificant due to the lower levels of chlorine production (FIGS. 13A-B). Nonetheless, the lowest energy consumption for COD (62 kWh/kg COD) was achieved with the Ti_{0.5}/EBNTA electrode. This value is also among the lowest value for electrochemical treatment processes. COD removal can be further enhanced by increasing the electrode area/reactor volume ratio, while energy consumption can be further reduced by increasing the conductivity of wastewater and by reducing the electrode separation distance.

FIGS. 15A-C are graphs comparing the removal of Ca²⁺ and Mg²⁺ during experimental human wastewater electrolysis using the disclosed electrode and prior electrodes. FIG. 15A shows removal of Ca²⁺ and Mg²⁺ during wastewater electrolysis with a Ti_{0.5}/EBNTA electrode in BP mode; FIG. 15B shows that same for a Ti/Ir electrode in MP mode, and FIG. 15C shows that same for a BDD electrode in MP mode at 5 mA/cm².

Operation in the BP mode appears to reduce depositional scaling. IC analysis (FIG. 15) showed that concentrations of Ca²⁺ and Mg²⁺ were constant in Ti_{0.5}/EBNTA and BDD (BP mode) electrolysis systems. While approximately 50% of Ca⁺ and Mg²⁺ were removed in the form of a mixed Ca, Mg-hydroxyapatite precipitate on the cathode surface in both the Ti/Ir and BDD (MP mode) systems. Such precipitation causes undesirable scaling. Additionally, the COD and NH₄⁺ removal efficiency of the Ti_{0.5}/EBNTA anode operated at 5 mA/cm² is commensurate with that of Ti/Ir anode operated at 25 mA/cm². The lower current input required by Ti_{0.5}/EBNTA electrode results in less gas evolution. Therefore, less visible foaming is produced.

In conclusion, the Ti/EBNTA electrode used in dual anode-cathode roles provides certain advantages for oxidant generation and wastewater treatment. Further, the Ti/EBNTA electrode is a relatively inexpensive material to prepare at moderate temperature (≦450° C.) under a normal atmospheric environment.

The disclosed electrodes may be employed in solar powered toilets and waste treatment systems, for example, those disclosed in U.S. Published Patent Application 2014/0209479, which is incorporated by reference herein in its entirety. For example, the source 38 of FIG. 1 herein may be a photovoltaic source. And the electrolysis can be done on human waste, such as the electrolysis of urine depicted in FIG. 17C of U.S. Published Patent Application 2014/0209479.

The disclosed electrodes may also be useful in the chlor-alkali industry. The chlor-alkali process is an industrial process for the electrolysis of NaCl brine. It is the technology used to produce chlorine and sodium hydroxide (lye/caustic soda), which are commodity chemicals required by industry. To perform a chlor-alkali process, any of the disclosed anodes may be placed and used in a reactor, such as one of those shown in FIGS. 1 and 2, for the electrolysis of NaCl brine. The reactor is filled with suitable NaCl brine. When placed in the reactor, the electrodes contact the NaCl brine. An anodic potential that is sufficient to generate reactive chlorine at the anode is then applied to the anode by a source, as shown in FIG. 1. As shown in FIG. 2, multiple anodes and cathodes can be used in the process.

The foregoing description is illustrative and not restrictive. Although certain exemplary embodiments have been described, other embodiments, combinations and modifications involving the invention will occur readily to those of ordinary skill in the art in view of the foregoing teachings. Therefore, this invention is to be limited only by the following claims, which cover the disclosed embodiments, as well as all other such embodiments and modifications when viewed in conjunction with the above specification and accompanying drawings.

1. An electrolysis electrode, comprising:
a substrate;
a nanotube array having a top surface and a bottom surface, the bottom surface contacting the substrate; and
a semiconductor layer contacting the top surface of the nanotube array.

2. The electrode of claim 1, wherein the nanotube array comprises TiO₂.

3. The electrode of claim 2, wherein the nanotube array comprises blue-black TiO₂.

4. The electrode of claim 1, wherein the semiconductor layer includes TiO₂.

5. The electrode of claim 1, wherein the semiconductor layer is about 100 nm thick.

6. The electrode of claim 1, wherein the semiconductor layer is applied by spray pyrolysis at a mass loading between 1.0 mg/cm² and 0.5 mg/cm².

7. The electrode of claim 1, wherein the semiconductor layer is applied by spray pyrolysis at a mass loading of about 0.5 mg/cm².

8. The electrode of claim 1, wherein the substrate is a metal conductor.

9. The electrode of claim 8, wherein the metal conductor is titanium.

10. A water purification system, comprising:
an electrode configured to be, at least in part, in direct contact with water, the electrode including
a substrate;
a nanotube array having a top surface and a bottom surface, the bottom surface contacting the substrate; and
a semiconductor layer contacting the top surface of the nanotube array.

11. The system of claim 10, further comprising a second electrode.

12. The system of claim 11, wherein the second electrode includes
a substrate;
a nanotube array having a top surface and a bottom surface, the bottom surface contacting the substrate; and
a semiconductor layer contacting the top surface of the nanotube array.

13. The system of claim 10, further comprising a voltage source connected to the electrode and a second electrode configured to contact the water.

14. The system of claim 13, wherein the voltage source is configured to switch polarity at a predetermined frequency so that the electrode operates as either an anode or a cathode based on the polarity of the voltage source.

15. The system of claim 10, further comprising an electrolysis vessel for holding the water, the electrode and a second electrode.

16. A method of manufacturing an electrolysis electrode, comprising:
synthesizing the nanotube array on the substrate by anodic oxidation of the substrate; and
depositing a semiconductor layer on the nanotube array by applying a first aqueous metal oxide precursor onto the nanotube array using spray pyrolysis.

17. The method of claim 16, further comprising:
anodizing the substrate and nanotube array in an electrolyte for a predetermined period of time.

18. The method of claim 17, further comprising:
rinsing the substrate and nanotube array with ethanol after anodizing; and
drying the substrate and nanotube array in a vacuum.

19. The method of claim 16, further comprising:
after depositing the semiconductor layer on the nanotube array, cathodizing the electrode.

20. The method of claim 19, further comprising:
cathodizing the electrode in a solution of NaClO₄ at a predetermined current density and for a predetermined amount of time.
